(19) United States
(12) Patent Application Publication
(10) Pub. No.: US 2007/0113420 A1
(43) Pub. Date: May 24, 2007

(54) Device for storing and drying sports equipment

(76) Inventor: Rolf Hatt, Habsburg (CH)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/573,907

(22) PCT Filed: Jan. 19, 2004
(86) PCT No.: PCT/CH04/00026

§ 371 Date: Mar. 29, 2006

(30) Foreign Application Priority Data
Dec. 18, 2003 (CH) 2179/03

(51) Int. Cl. F26B 25/18

(52) U.S. Cl. 34/239

(57) ABSTRACT

The invention relates to a device (1) which is used to store and dry sports equipment. Said device comprises two vertical supports (2) which are connected together in a communicating manner by means of a transversal carrier (3). Several tubular elements (12, 13, 18, 20) are strapped to the two vertical supports (2) which also communicate therewith. The above-mentioned tubular elements comprise air outlets (30). Air is blown through said air outlets (30), said air being introduced into the communicating tubes by means of a ventilator (31). A flange element (32), which is embodied in the form of a T in the transversal carrier (3) is used in order to mount the ventilator (31). The individual tubular elements are formed in such a manner that they can be adapted, in a particularly precise manner, to the various elements of sports equipment.

This application is a §371 national phase filing of PCT/CH2004/000026 filed Jan. 19, 2004, and claims priority to a Swiss application No. 2179/03 filed Dec. 18, 2003.

The present invention relates to a device for storing and drying sports equipment, according to the preamble of patent claim 1.

Sports equipment, in particular for ice hockey players, inline hockey players and football players comprise many parts which are not suitable for drying in a tumble dryer. This in particular relates to shoes, shin pads, armoured trousers, elbow protectors, chest armour pieces, gloves and helmets. Such equipment is relatively heavy and voluminous. Accordingly, the storage and drying of such sports equipment is a problem. The drying via a heating on coat hangers or washing lines may be accomplished in the fewest of cases. In order in particular to solve the drying to a satisfactory extent, air suctioning is provided in the wardrobes of various sports clubs, above the compartments which are suitable for storing the sports equipment. Various special drying devices are known for the drying of individual parts of sports equipment. Thus for example a stand is known from U.S. Pat. No. 5,974,693 which may be arranged in a drum of a tumble dryer and on which several shoes may be fixed for drying. Stands which are generally suitable for hanging up and drying clothes in general are also present. Here U.S. 468,873 is referred to purely by way of example, which discloses a rotary clothes dryer with a covering casing and a blower, or another example is a valet as is known from U.S. Pat. No. 3,722,703. This valet, just as the clothes hanging and drying stand according to GB-A-860 208 serve for hanging up clothes, wherein the hanging-up stand is designed in a manner which is as space-saving as possible. Stands which are particularly suitable for storing sports equipment are also known. With regard to this, U.S. Pat. No. 6,164,465 or U.S. Pat. No. 5,617,958 are referred to by way of example. These two last mentioned stands, just as the device according to U.S. Pat. No. 6,340,188, are not however suitable for drying sports equipment.

Devices are also known for storing and drying sports equipment, in particular of ice hockey players or football players. Thus U.S. Pat. No. 3,802,573 illustrates a multi-membered hanging hook which is suitable for receiving chest armour pieces.

A device of the initially mentioned type is known from U.S. Pat. No. 5,377,849. Here it is the case of a stand which may be screwed together from a multitude of tube- or rod elements and which in particular serves for the storage and transport of such sport equipment. With this, one should take particular care that the individual elements of the sports equipment does not come to lie above one another, in order to improve their drying. With this known solution, one takes care that the complete stand may be screwed together of individual tube elements, specifically tube sections, tube bends, tube branchings, etc. This permits the complete stand to be manufactured of a set of part elements which may be screwed together by a purchaser.

This known solution is hardly suitable for active drying and is extremely costly with regard to manufacturing technology.

It is the object of the present invention to provide a device for the drying and storage of sports equipment, in particular for ice hockey players and football players, which may be manufactured in a rational manner and serves for the active drying of the sports equipment.

This object is achieved by a device with the features of patent claim 1. Further advantageous design variants are to be deduced from the dependent claims and their significance is examined in the subsequent description with reference to the accompanying drawings.

One preferred embodiment example, as well as certain details are represented in the drawings. There are shown in:

FIG. 1 a view of the device according to the invention and

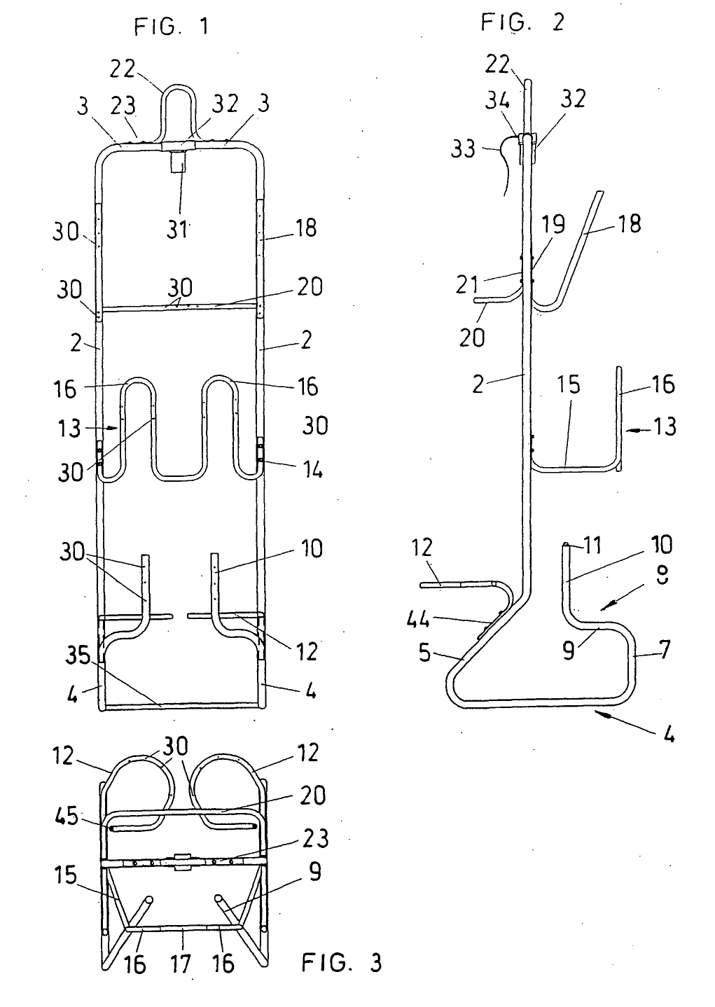

FIG. 2 a lateral view of the same device, whilst

FIG. 3 shows a view of the device from the top. In

FIG. 4 a part section through the flange element is represented, on which the ventilator is assembled.

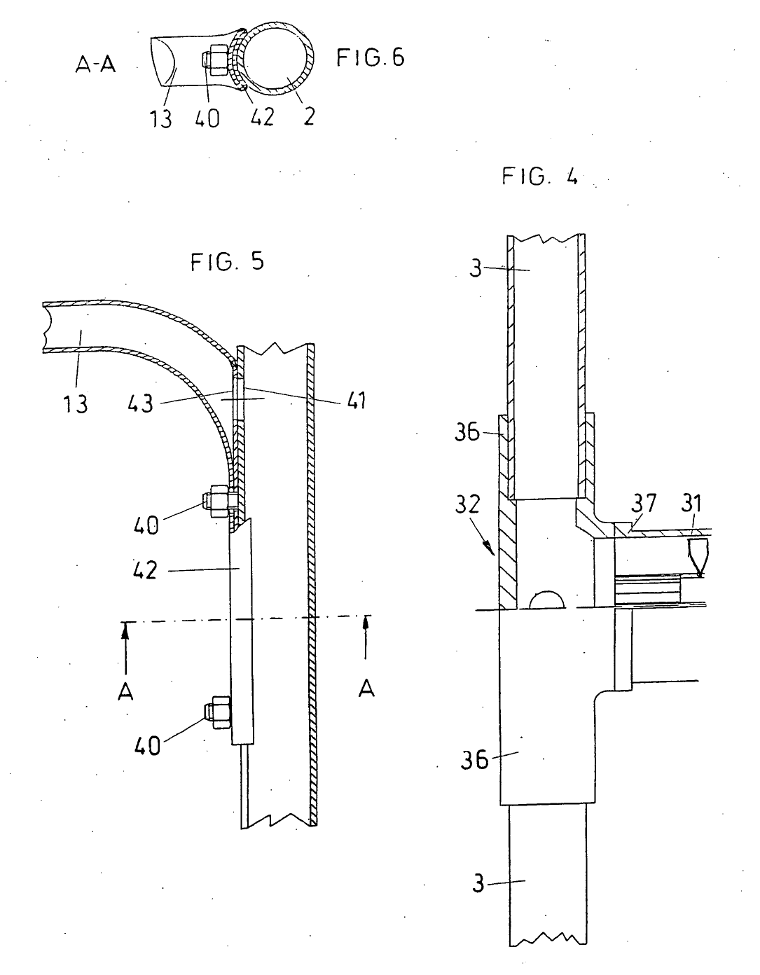

FIG. 5 shows an axial longitudinal section through a vertical support in the region of a connection, with a communicating connection and

FIG. 6 a diametral section through the connection along line A-A in FIG. 5.

The device according to the invention is indicated in its entirety at 1. It comprises two vertical supports 2 which are indirectly connected to one another via a transverse support 3, and are bent of two tube sections and run in a plane. The lower ends of the two vertical supports 2 are in each case shaped into a base foot 4. For this, a first tube section 5 is bent obliquely to the rear and running downwards, whereupon a second horizontally running tube section 6 follows, which forms the actual base surface. This tube section 6 extends with respect to the plane in which the two vertical supports 2 run, somewhat further to the front than they run behind the mentioned plane. Connecting to the horizontal tube section 6 are the free tube ends 8 which, serving for sticking on the shoes, run upwards firstly in a first vertical section 7 and then into a horizontal section 9 obliquely to the centre, to then finally end in a vertical end section 10. The end sections 10 are closed at 11. The horizontal section 9 runs towards the middle in order on the one hand to apply the weight over the base surface which is defined by the two horizontal tube sections 6, but in particular to lengthen the path of the horizontal section 9, in order by way of this to also be able to stick the shoe with a hollow leg onto the free tube ends 8.

In each case, a circular, open bow 12 is fastened on the first tube section 5 which is directed obliquely to the rear and to the bottom. Both bows 12 serve for mounting shin pads. They are fastened on the tube section 5 via connection locations 44 and are closed at the end side with a peg 45.

A tube element 13 is fastened to the two vertical supports 2 in a communicating manner above the two free tube ends 8 for storing and drying the shoes. This tube element 13, after a connection location 12, runs horizontally to the front and the middle, in a first rest section 15. Subsequently there follows two retaining bows 16 which are directed perpendicularly upwards, and are perpendicular to the plane spanned by the two rest sections 15. A connection section 17 is present between the two retaining bows 16, which again runs in a plane which is formed by the two rest sections 15. The complete tube section 13 serves for hanging armoured or padded trousers. The two retaining bows 16 thereby come to lie in the two trouser legs.

A hook-like tube element 18 is fastened on the two vertical supports 2 above the tube element 13, in each case at the same height. The two hook-like tube elements are bend around in the manner of a hairpin from their respective connection location 19, and run upwards at an acute angle with respect to a plane which is spanned by the two vertical supports 2. These hook-like tube elements 18 on the one hand serve for accommodating elbow protectors which come to hang at the bend at the bottom, whilst the free ends of the hook-like tube element 18 serve for sticking on gloves.

In the example shown here, a further tube element 20 is present which is bent in a U-shaped manner and may serve as a towel holder. This tube element designed as a towel holder extends perpendicularly to the rear with respect to the plane which is spanned by the two vertical supports 2. Accordingly, the connection locations 21 of this tube element 20 on the two vertical supports 2 lie diametrally opposite the connection locations 19 of the hook-like tube elements 18. The free distance between the tube element 20 and the two circular open bows 12 is relatively large, so that the tube element 20 which is formed as a towel holder is also suitable for hanging and drying a shirt.

Finally, yet an upwardly bent centrally arranged bow 22 is fastened on the upper transverse support 3. The bow 22 serves for holding a helmet. The bow 22 is connected to the transverse support 3 via the two connection locations 23.

The transverse support 3 itself serves for storing a chest armour piece. The ventilation of the chest armour is effected by way of the suction air of the ventilator.

So that the complete device 1 not only serves for storing and holding sports equipment but additionally may also serve for active drying, the various tube elements which are connected to the two vertical supports 2 comprise air exit openings 30. Only the two vertical supports 3, the transverse support 3 and the bow 22 for the helmet have no air exit openings 30. In particular the air exit openings are present on the hook-like tube elements 18, on the two retaining bows 16 of the tube element 13, on the circular open bow 12 and finally on the end sections of the base feet 4. The tube element 20 serving as a towel holder may also be provided with air exit openings 30. The air supply to the air exit openings 30 is effected by way of a ventilator 31. This is held on a flange element 32. The electrical ventilator 31 is fed via a cable 33 which is represented in an indicated manner. The ventilator 31 operating with a low voltage may comprise a transformer integrated in the flange, advantageously however only a plug-and-socket connection 34 is provided in order to connect the cable 33. The cable 33 may then be connected to different transformers and adapters without any problem.

As already mentioned, the two vertical supports as well as the transverse support 3 may be manufactured of a single tube section. It is however simpler to individually manufacture the two vertical supports with a part of the transverse support 3 and to use the flange element 22 for connecting the two transverse support sections. In this case, the bow 22 simultaneously has the function of a reinforcement beyond the flange element 32, and leads to an improved clamping of the flange element in the transverse support 3. The transverse connection between the two vertical supports 2 is increased additionally by the tube elements 20 and 13. Finally it may be useful to provide a stiffening support 35 between the two base feet, which lies perpendicularly below the horizontal transverse support 3 and therefore may only be recognised in FIG. 1. Of course, further stiffening supports may be arranged between the two vertical supports 2, but this would hardly be necessary. The stiffening support 35 has no air exit opening 30. Neither does it lead air. This is also the case with the bow 22.

The flange element 32 is shown in detail in FIG. 4. The ventilator 31 is shown merely schematically. The flange element 32 is designed as a T-piece. The two lateral ends are formed as muffs 36 in which the two sections of the transverse support 3 are insertably held. The branching of the T-piece is designed as a bracket 37 on which the ventilator 31 for example may be screwed or bonded. The T-piece may be technically manufactured of plastic injection moulding and thereby the valve housing may be designed as a part of the T-piece.

The possible design of the connection locations as are present at 14, 19, and 44 are shown in detail in the FIGS. 5 and 6. The connection location 14 is shown here purely by way of example. The connection location 14 represents the connection between the vertical support 2 and the tube element 13. The screw bolts 40 are attached on the vertical support by way of a jig, and the air connection opening 41 is drilled into the vertical support 2.

The screw bolts 40 may be welded or screwed on the vertical support 2. In the latter case, the jig is a pure drill jig and accordingly a thread is cut into the two bores which serve for receiving the screw bolts 40. The connection in the FIGS. 5 and 6 is shown as a welding connection. The already drilled tube element 13 at its end is pressed together on a female die which has the cross-sectional shape of the vertical support 2. Subsequently with a drill jig which is equal and opposite to the drill jig for setting the bore, one would incorporate suitable bores for the screw bolts 40 and the air connection 41. The pressed-together end 42 of the tube element 13 may then be pushed over the screw bolts 40, and simultaneously the air connection opening 43 of the tube element 13 comes to lie exactly over the air connection opening 41 in the vertical support 2. In principle, a seal may be incorporated in the region of the two communicating air connection openings 41 and 43, but this is usually not required. The free passage in the region of the air connection openings 41 and 43 is significantly larger that the possible leakage opening. Anyway, the air which possibly exits the leakage openings in any case also serves for the drying, since this likewise acts in the region of the sports equipment to be dried. As is known, the air would take the path of the least resistance. Accordingly, in the upper region, thus on the hook-like tube elements 18 and the tube element 20 designed as a towel dryer, one would provide less air exit openings or provide these with a smaller diameter than the air exit openings 30 on the tube element 13 or on the circularly open bow 12. The air exit openings 30 on the end sections 10 which come to lie in the shoes, may again be designed slightly larger, or here the number of air exit openings may be larger.

In contrast to the known state of the art, the device according to the invention not only has the advantage that this may be manufactured much less expensively than the device forming the closest lying state of the art, but in particular the drying procedure is significantly accelerated due to the active conveying of air. This is extremely important for active sportsmen since the training and game intervals are relatively short and accordingly the equipment must be dried very quickly. As is known, such sport equipment is expensive and it is therefore not possible for most sportsmen to have a multiple of their sports equipment. Furthermore, the formation of germs is significantly reduced by way of the active aeration.

### LIST OF REFERENCE NUMERALS

1 device
2 vertical support
3 transverse support
4 base feet
5 first tube section
6 horizontal tube section
7 vertical section
8 free tube ends
9 horizontal section
10 end section
11 closure
12 circular open bow
13 tube element
14 connection location
15 rest section
16 retaining bow
17 connection section
18 hook-like tube element
19 connection location
20 tube element as a towel holder
21 connection location
22 bow for helmet
23 connection location
30 air exit openings
31 ventilator
32 flange element
33 cable
34 connection
35 stiffening support
36 muffs
37 bracket
40 screw bolts
41 air connection opening
42 end tube elements
43 air connection opening
44 connection
45 peg

1. A device for storing and drying sports equipment, consisting of a support stand formed of tubes and in the form of a valet with at least one vertical support and a transverse support suitable for holding a chest armour piece, as well as two tube ends for sticking on shoes, as well as several holders of tube elements which are integrally formed on at least one vertical support, for receiving further parts of sports equipment, wherein the at least one vertical support and the transverse support as well as all tube elements are in communicating connection, and a flange element with a ventilator fastened thereto and with an electrical connection for feeding the ventilator is present, and that the tube elements and tube ends for sticking on the shoes, comprise air exit openings, characterised in that two vertical supports are present and at least one air-leading transverse support, which serve for the transport of air and are free of air exit openings and that the two vertical supports at the lower ends are in each case bent into a base foot, so that the vertical supports are located approximately centrally over the base surfaces of the base feet, and wherein all previously mentioned parts are bent from a tube.

2. A device according to claim 1, characterised in that the flange element with the ventilator is arranged on at least one transverse support.

3. A device according to claim 1, characterised in that the air flow produced by the ventilator is divided and introduced in both directions into the transverse support by the flange element.

4. A device according to claim 1, characterised in that the two free ends of the tube forming the base foot are bent towards the centre and upwards, and are suitable for receiving shoes, wherein air exit openings are only provided in the last, vertically upwardly projecting section.

5. A device according to claim 1, characterised in that circular, open bows of tube elements are present on the base feet at the region which lies opposite the ends serving for receiving the shoes, and these tube elements are provided with air exit openings and are suitable for holding shin pads.

6. A device according to claim 1, characterised in that the two vertical supports are connected to one another above the base feet by way of a tube element, wherein the tube element, out of the plane in which the two vertical supports run, is bent to the front to the front end of the base feet and here in a plane parallel to the plane of the two vertical supports, is shaped into two upwardly directed retaining bows, wherein the tube element at least in the region of the retaining bows comprises air exit openings.

7. A device according to claim 1, characterised in that in each case a tube element as a hang-up hook with air exit openings is integrally formed on both vertical supports at approximately the same height, and serve to receive elbow protectors and gloves.

8. A device according to claim 1, characterised in that the two vertical supports are connected to one another below the transverse support by way of a tube element which is bent to the rear, out of the plane of the vertical supports, but runs parallel to the transverse support.

9. A device according to claim 1, characterised in that an upwardly bent, centrally arranged bow is arranged on the transverse support and is suitable for serving as a helmet carrier.

10. A device according to claim 1, characterised in that all tube elements connecting to the two vertical supports and the transverse support, at their connection locations are pressed together according to the outer shape of the vertical supports, and comprise punchings for the screwable fastening on the mentioned supports, as well as in each case an air connection opening which communicates with an air connection opening in the corresponding support in the assembled position.

11. A device according to claim 1, characterised in that the flange element as a T-piece is provided with a support bracket for the ventilator, and an electrical plug-and-socket connection is provided for feeding the ventilator.
